(19) United States
(12) Patent Application Publication
(10) Pub. No.: US 2016/0227703 A1
(43) Pub. Date: Aug. 11, 2016

(54) Roller Segment for Separating and Cleaning Devices of Root Crop Harvesters and Method for its Manufacture

(71) Applicant: Grimme Landmaschinenfabrik GmbH & Co. KG, Damme (DE)

(72) Inventors: Franz-Josef Dettmer, Ankum (DE); Mike Broermann, Damme (DE); Richard Tepe, Damme (DE)

(21) Appl. No.: 15/018,914

(22) Filed: Feb. 9, 2016

(30) Foreign Application Priority Data
Feb. 10, 2015 (DE) 10 2015 101 900.0

(51) Int. Cl. A01D 33/08; B07B 1/46; A01D 17/06; B07B 1/15

(52) U.S. Cl. CPC A01D 33/08; B07B 1/155; B07B 1/4618; A01D 17/06

(57) ABSTRACT

A separating and cleaning device for a root crop harvester has at least one separating and cleaning stretch. In this separating and cleaning stretch, at least one roller is arranged that is assembled of one or several roller segments that in direction of a longitudinal roller axis are coaxially adjoining each other. These roller segments are provided with a jacket part made of an elastically yielding material and provided with entrainment ribs projecting outwardly. This jacket part interacts radially inwardly with a receiving area that is provided with free spaces delimited by intermediate webs as well as a through opening, wherein the receiving area can receive a polygonal shaft or drive element for torque transmission. The roller segments, beginning at their inner through opening, are provided with a multi-layer structure in radial outward direction.

### BACKGROUND OF THE INVENTION

The invention concerns a roller segment for separating and cleaning devices, in particular of root crop harvesters, or similar sorting and cleaning devices of an agricultural machine in agricultural engineering, provided with at least one separating and cleaning stretch. With such a device generally usable in sorting and cleaning devices in agricultural engineering, potatoes that are to be separated from a mixture flow are separated from admixtures in particular during a lifting process.

The separating and cleaning stretch is provided with at least one roller that is assembled of one or several roller segments that in direction of a longitudinal roller axis are coaxially adjoining each other, wherein the roller segments are provided with a jacket part comprised of an elastically yielding material and comprising entrainment ribs projecting outwardly. The jacket part is interacting radially inwardly with a receiving area that is provided with recesses delimited by intermediate webs as well as with a through opening. The receiving area receives a polygonal shaft or similar drive element for torque transmission. The invention further relates to a method for manufacturing the roller segments of the aforementioned kind that are provided for a separating and cleaning device on root crop harvesters or similar devices of agricultural engineering and comprises an elastic jacket part.

In a device of the aforementioned kind for separating potatoes from admixtures in accordance with U.S. Pat. No. 5,775,435, rollers oriented transversely to the separating stretch are provided that are formed monolithically of elastically yielding material and therefore have a very high soft-elastic deformation capability. These rollers are connected to a drive in the area of a polygonal shaft penetrating through a central through opening so that the area which is located in circumferential direction above this through opening acts like an elastic jacket part with radially projecting entrainment ribs on the supplied mixture of soil and crop.

Based on the afore described roller construction, in a design according to EP 1 082 912 A2 it is provided that the rollers comprise a jacket part that is formed as a monolithic formed body with elastic properties. This jacket part which is comprised in particular of polyurethane is secured on a support body which is provided as an inner part and comprised of two identically shaped sheet metal parts. It is conceivable in this context that the support body in the area of the through opening surrounding the polygonal shaft of a drive is formed with an integral inner part so that the jacket part which is monolithic in cross-section comprises a special contour in the area of its inner part and, in this way, a more shape-stable fixation of the radially adjoining “elastic” jacket part is enabled.

According to EP 1 661 471 B1, the monolithic “jacket part concept” is improved in that now individual roller segments can be adjoined in a row in axial direction of the system. The jacket parts are formed in monolithic embodiment preferably of polyurethane and, in the area of a central through opening, can be pushed onto the appropriate polygonal shaft. The through opening in this context is delimited by two diametrically opposed angle members of sheet metal so that the stability for torque transmission is ensured.

In a separating device according to GB 2 432 097 A, similar to U.S. Pat. No. 5,775,435, monolithic rubber rollers with elastic outer profiles are provided, respectively. These rubber rollers also comprise in cross-section the central through opening and, at a spacing thereto, respective radial deformation chambers are formed so that different deformation properties for the respective separating process are made available.

It has been found that in the known monolithic embodiments of rollers or roller segments the use of long-term stable and sufficiently elastic polyurethane materials is required. Accordingly, high quality material is used that disadvantageously affects the manufacturing costs of the entire separating and cleaning device.

In a solution according to EP 2 223 587 B1, a variable elasticity in the area of a roller, similar to EP 1 661 471, is achieved in that, beginning at the comparatively shape-stable receiving area provided for the drive action, respective intermediate webs are extending to the outer jacket part. In the monolithically formed roller body an elastic tubular element that acts as an additional support means can be introduced in the area of the intermediate webs.

The invention concerns the problem to embody roller segments that are provided for separating and cleaning devices and a method for their manufacture in such a way that, for at least unchanged good separating and transfer functions, optimal deformation capability, and improved long-term stability of the rollers, their application-specific variable manufacture is possible more simply so that, as a whole, a reduction of the manufacturing costs is achieved.

### SUMMARY OF THE INVENTION

The invention solves this problem with respective roller segments in that the respective roller segments, beginning at their inner through opening, are provided with a multi-layer structure in radial outward direction.

The invention solves this problem in regard to the method in that, beginning with a semi-finished product that can be produced as a formed core body with abutment profile, the semi-finished product is connected with a formed jacket body, comprising at least in some areas an elastic jacket part, to form a structure of at least two-layers as a component unit.

With regard to important further embodiments, reference is being had to the dependent claims.

Separating and cleaning devices for root crop harvesters or similar devices of agricultural engineering are using cleaning rollers that are in particular assembled of roller segments whose jacket part, provided in particular with outer entrainment ribs, can comprise variably designable soft-elastic deformation capabilities and properties in accordance with its cross-sectional configuration. The soft-elastic materials which can be used efficiently and with gentle action on the root crop entail however high manufacturing costs.

Based on the known embodiments of cleaning rollers with roller segments, the simplified concept according to the invention provides that the roller segments that, up to now, exhibit a monolithic elastomer configuration with zones of different stiffness or are formed with integrated stiffening metal supports as additional support means are formed of a multi-layer structure in an improved embodiment according to the invention.

Conceivable in this context is also to employ, instead of the roller segments assembled to a roller, a complete roller as a “monolithic part” with the multi-layer structure according to the invention. The manufacture of agricultural smooth rollers with multi-layer structure is also possible.

This multi-layer structure is defined respectively in that, beginning at the inner through opening of the roller segment, the roller segment in radial outward direction can be constructed of respective layers with variable layer thickness. In this context, it is provided that for this functional structure at least an inner layer, comprised of at least one comparatively inexpensive support material, and at least one jacket part top layer, having a comparatively minimal layer thickness and provided as a functional layer located on top and made of expensive deformation material, are combined. In this context, the manufacturing costs of such roller segments or rollers can be advantageously reduced.

The system according to the invention is designed such that the roller segment has preferably only a two-layer structure which is provided with a first layer that forms the through opening and a second layer, correlated therewith radially, as an elastic jacket part. Advantageously, a structural configuration can be designed that makes additional metal structures, support layers or similar support means of known roller segments expendable.

It has been found that the at least two layers of the roller segment in this context can be formed advantageously of different plastic materials. These two plastic materials in regard to their elasticity-stiffness ratio are optimally matched relative to each other. In this way, it is achieved that, on the one hand, a driving torque is immediately and reliably transmittable onto the inner layer of the two-layer segment that is forming the receiving area for a drive element and, on the other hand, the outer layer as a functional jacket part comprises a structure which is matched to the specific conditions of use.

An optimal configuration of the roller segments that are functionally optimizable in the area of the two plastic material layers provides that its inner layer in radial cross-section is in the form of a formed core body that comprises at least a circumferentially arranged abutment profile. This formed core body which is comprised of a comparatively bending-stiff material has correlated therewith a formed jacket body that defines the outer “elastic” layer. In this context, the two-layer structure in the connecting area of abutment profile and counter profile of the formed jacket body is connected such that the latter, in use of the roller in the functional state of the system, comprises a generally known rotational fixation in the two-layer composite.

It is understood that for this abutment profile/counter profile connection, variable cross-section contours can be used in accordance with the roller concept. Based on the dimensions of the roller segment, different engagement lengths of the respective connection profiles are conceivable in radial direction and a variable number of afore described profile connections are possible in circumferential direction of the roller segment.

It has been found that based on the inner formed core body that is effective as a comparatively shape-stable structure in the cross-section of the roller segment, the formed jacket body, which forms together with the formed core body a component unit and that is a layer that can be varied in regard to thickness, enables respective combinations of the layers with very different dimensions. In this context, the formed jacket body, in particular in radial direction, can define an outer functional area of the roller segment that is dimensionally variable by manufacturing technology and in this context is comprised, at least in some areas, of the elastic material so that different root crop harvesters can be matched to the respective crop in this way. The roller segments can be provided in this context at the outer circumference with entrainment profiles which, as functional partial areas, are known in general.

An optimally designed realization of this two-layer component unit provides that the formed core body is provided as a pre-manufactured semi-finished product and the latter is assembled with the formed jacket body, correlated therewith at least in some areas, to the unit that is constructed of the at least two different materials. With regard to the use of the roller segment, it is understood that the formed jacket body is designed as an elastic envelope body which surrounds completely in circumferential direction the formed core body and comprises in particular the “deformation areas” that utilize the inwardly oriented compensation movements in the radial direction.

Based on the concept according to the invention of the two-layer structure, it is provided that between the formed core body and the formed jacket body in the area of the respective abutment/counter bearing profiles different options for manufacturing the component unit are conceivable. In this context, it is provided that, at least in some areas, respective material-fused, friction-connected and/or form-fit connecting zones are formed.

The embodiment of the two layer system according to the invention provides also that the formed core body itself and/or the formed jacket body itself can be formed of several materials, respectively. Preferably, in this context different combinations of plastic materials are in principle conceivable so that the material-specific manufacturing costs are correspondingly variable.

In accordance with the purpose of use, it is provided that the respective formed core body is formed of a material that, in relation to the respective material characteristics, has at least a greater stiffness than the formed jacket body. With regard to manufacturing costs, it is provided that the formed core body that is comparatively greater particularly with regard to its volume is produced of a material which is less expensive based on cost comparison.

Extensive tests on prototypes for realizing the two-layer roller segments have shown that the component unit advantageously enables a formed core body made of thermoplastic material, thermosetting plastic material and/or glass fiber reinforced plastic material. It is combined according to the invention with a formed jacket body which is formed at least in some areas of soft-elastic plastic material or rubber. This formed jacket body is comprised preferably of polyurethane, thermoplastic polyurethane, or thermoplastic elastomer.

The concept realization of the abutment profile which is radially outwardly projecting away from the formed core body provides that it is preferably formed as a partial section of a thread profile provided with a pitch. Accordingly, the formed core body is shaped like a “spiral core”. An effective connection for this “ascending” abutment profile is provided in that it engages a receiving groove of matching shape that is provided on the inner side of the correlated formed jacket body so that, in this way, at least a form-fit connection of the two layers is formed.

In this connecting position of the formed core body and of the formed jacket body, a deformation structure formed with essentially known free spaces results in longitudinal direction of the connected bodies in the near area of the connection profiles extending as “intermediate webs”. In accordance with the configuration of this deformation structure delimited by the connection profiles, a variable configuration of the roller segment with regard to its elastic deformation properties can be achieved. In this context, the also “spiral-shaped” extending entrainment profiles are formed radially outwardly, adjoining the free spaces.

In this way, it is apparent that different embodiments of the elasticity system are conceivable by means of the afore described combination of connection profiles and deformation structure. In particular, the free spaces which are extending between the support connections extending in a coil shape can be variably dimensioned in radial direction of the deformation structure. These free spaces which are extending in a coil shape in longitudinal direction of the formed jacket body can form in cross-section an angular or round channel structure. Also, additional longitudinal and/or transverse ribs are conceivable within the deformation structure.

A configuration in the area of the formed core body that is important for the strength of the afore described connection configuration provides that their radially projecting abutment profiles each are formed as “coiled” strip profiles with top-side expansion projection. In this context, the strip profiles, in turn, are provided with respective transverse openings so that in this area, in addition to the radial engagement of the abutment profiles by the formed jacket body in the area of the expansion projections, respective tangential connection areas become utilizable. In this context, it is understood that with the afore described connection profiles, on the one hand, different tensile and compressive loads can be absorbed that in use of the roller are introduced from the outer functional area of the formed jacket body into the system and, on the other hand, the drive torque in the area of the central through opening can be optimally introduced into the two-layer structure.

In an advantageous embodiment of the formed core body, a contour that delimits it as a profile frame is formed in the area of the through opening. Beginning at the through opening, respective projecting webs extending toward an envelope cylinder part are oriented outwardly in radial direction. Several of the coiled strip profiles are provided, in turn, on its outer circumference. Accordingly, with comparatively minimal material expenditure, a formed core body can be produced that in cross-section is essentially embodied as a “framework of lightweight construction”.

A conceivable variant of the multi-layer structure provides that the latter comprises a “third” additional layer interacting with the formed core body in the area of the central through opening. In this context, this additional layer can be comprised of metal. Also, it is provided that the additional layer that is comparatively “thin” in regard to its material thickness can be made of plastic material. In this context, a material with elastic and thus vibration-damping characteristic values is conceivable.

For producing the afore described component unit of the two layers in the area of the correlated profiles, the manufacture of a form-fit connection by appropriate compression of the two layers of the structures is in principle conceivable. A preferred embodiment provides that in the area of the connection profiles a fused material connection is generated. This can be realized preferably by dead-mold casting that is dependent on the material properties of the two layers. Also, it is conceivable that an adhesive connection is combined with a friction connection in the area of the connection profiles.

For producing this roller segment provided for a separating and cleaning device, a multi-step process sequence is provided in particular. In this context, in a first process step a formed core body with abutment profile is produced as a semi-finished product. The latter can then be completed to the two-layer structure as a component unit by means of a formed jacket body that comprises at least in some areas the elastic jacket part.

A conceivable variant provides that the formed core body and the formed jacket body are provided as respective semi-finished products comprising complementary connection profiles. These two semi-finished products can then be connected by appropriate plug-in and/or pressing methods by a friction connection and/or form-fit connection in such a way that at least the connection stability that is required in circumferential direction between the two “individual parts” of the two-layer system during use in the roller is ensured.

The optimal embodiment of the connecting process provides however that the two-layer structure is produced by a fused material connection that is provided at least in some areas between the formed jacket body and the formed core body. Based on generally known manufacturing phases, it is provided according to the invention that the formed jacket body is generated by a casting process that encloses at least in some areas the formed core body and, at the same time, in addition to a form-fit connection, a fused material connection between the two layers of the structure can be produced.

Also, it is conceivable that the two-layer structure of the component unit can be generated by an injection molding process.

Based on the material properties of the materials used for the two layers, connection combinations can be produced in this context which comprise, in functionally relevant fused material connecting zones, layer or penetration structures that are variable in accordance with the process parameters. In this process phase with a layer-composite manufacture of the roller segment, the geometrically variable configuration of the two components forming the layers is also to be taken into consideration because a respective optimization of the process parameters is also conceivable based on the geometric shapes.

An expedient embodiment of the process control provides that the two-layer roller segments are produced by a casting process in a casting mold. In this context, the pre-shaped formed core body is inserted as a semi-finished product into the casting mold such that a casting zone remains that is to produce the formed jacket body. This casting zone is subsequently filled with the liquid elastomer plastic material. Subsequent to a material-specific hardening phase, the roller segment can then be removed from the casting mold as a two-layer component unit.

In accordance with the afore described process sequence, it is conceivable that during the casting process a stabilizer is introduced into the formed core body that stiffens the central through opening. It is likewise conceivable that in place of a one-piece embodiment of the casting mold a multi-part component group is used or the two plastic materials are simultaneously or sequentially introduced into a casting mold that is to be appropriately adjusted and, in this way, the complete roller segment is produced in one process sequence.

A further process control for fused material connection of the two components pre-manufactured as layers provides that the formed jacket body can be connected with the formed core body also by a vulcanization process that is carried out at least in some areas.

### BRIEF DESCRIPTION OF THE DRAWINGS

Further details and advantageous embodiments of the invention result from the following description and the drawing in which the embodiment of the separating and cleaning device according to the invention with respective roller segments as well as a device for their manufacture are illustrated.

FIG. 1 to FIG. 3 show several views of a roller segment with a generally known design in the area of the functional outer circumference.

FIG. 4 is a partially sectioned side view similar to FIG. 1 with illustration of a multi-layer structure according to the invention in the interior of the roller segment.

FIG. 5 is an end view of the roller segment according to the invention according to FIG. 4, partially sectioned.

FIG. 6 is a perspective illustration of the roller segment according to FIG. 4, partially sectioned.

FIG. 7 is a rear view of a formed core body, provided in the interior of the roller segment, as a semi-finished product according to the invention with counterclockwise outer profiling.

FIG. 8 is a front view of the formed core member according to FIG. 7.

FIG. 9 is a rear view similar to FIG. 7 with clockwise outer profiling on the formed core body.

FIG. 10 is a front view of the formed core body according to FIG. 9.

FIG. 11 is a perspective basic illustration of a casting mold provided for producing the two-layer roller segment with formed core body as a pre-formed semi-finished product located above in insertion position.

FIG. 12 is a partially sectioned view of the casting mold according to FIG. 11 with inner formed core body.

FIG. 13 is a partially sectioned view of the embodiment of the casting mold according to FIG. 12 with a jacket part surrounding as an outer layer the inner formed core body.

FIG. 14 is a perspective basic illustration similar to FIG. 11 showing a removal phase of the roller segment, now comprised of two layers, from the casting mold.

FIG. 15 is a partially sectioned view of a second embodiment of the roller segment that comprises a formed core body combined of two partial bodies with the formed jacket body surrounding them.

FIG. 16 is an enlarged individual illustration of the formed core body according to section line XVI-XVI of FIG. 8.

FIG. 17 is a perspective detail illustration of a separating and cleaning device comprising rollers made of roller segments.

FIG. 18 is a basic illustration of the separating and cleaning device with side view of the roller pairs forming a separating stretch.

FIG. 19 and FIG. 20 are views of the roller segment similar to FIG. 2 and FIG. 3 wherein in the area of the through opening at least one third layer for receiving the drive element is provided.

### DESCRIPTION OF PREFERRED EMBODIMENTS

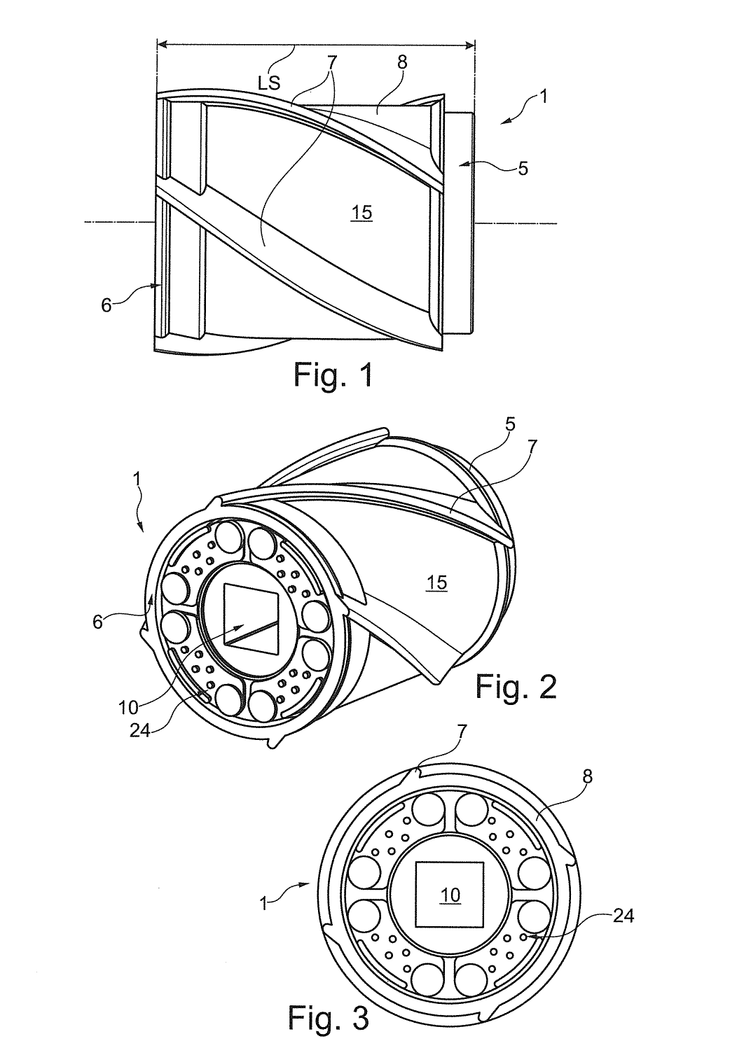

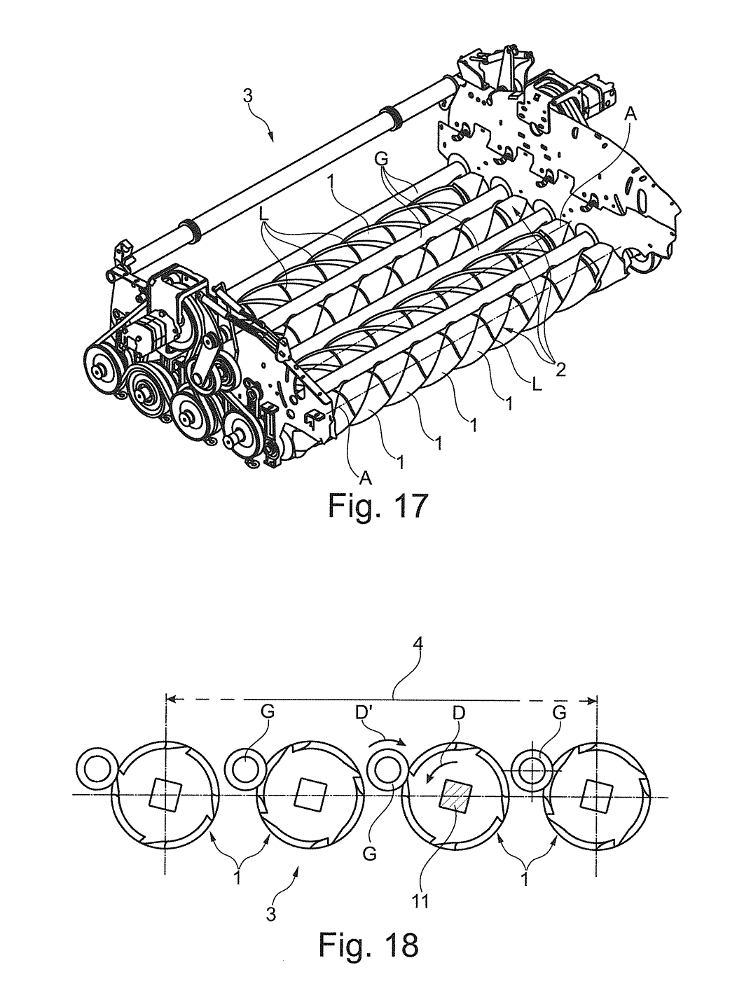

In FIG. 1 to FIG. 3, a roller segment 1 is illustrated that is provided for constructing an assembled roller 2 (FIG. 17). From these overview illustrations it is apparent that, with regard to the functional individual parts of such roller segments 1, their “outwardly positioned” contour design corresponds substantially to the construction of the aforementioned kind according to EP 1 661 471 B1. When looking at both FIG. 17 and FIG. 18, it is apparent that preferably several rollers 2 are used for the separating and cleaning devices 3 which are to be used in particular in agricultural machines for root crop harvesting or processing, not illustrated in detail here.

A separating and cleaning stretch 4 (FIG. 18) that can be used as an independent unit can be assembled of several such rollers 2 and, in its area, preferably several rollers 2 are arranged parallel to each other in the direction of their longitudinal roller axis A in combination with smooth rollers G or similar additional elements. In the direction of the longitudinal roller axis A coaxially adjoining roller segments 1 are arranged such that their respective end profiles 5, 6 (FIG. 1) can contact each other or can be plugged into each other (gap L, FIG. 17).

In this context, the roller segments 1 in already known embodiment are provided with a jacket part 8 that is made of an elastically yielding material and comprises outwardly projecting entrainment ribs 7. This jacket part 8 in the construction according to EP 1 661 471 B1 is provided at its inner side with a receiving space that comprises recesses delimited by intermediate webs, a central through opening 10 as well as support means. This area of the through opening 10 is shaped such that preferably a polygonal shaft or similar drive element 11 (FIG. 18) can be used or inserted for torque transmission (arrow D, FIG. 18).

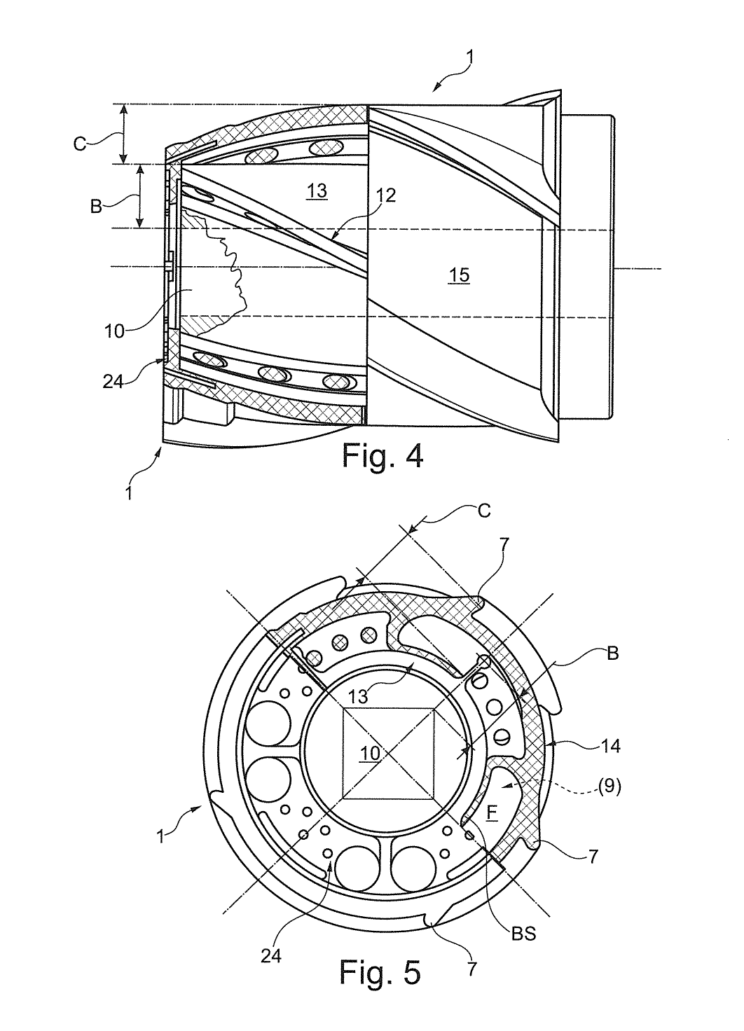

Based on the plurality of already known constructions, similar to the roller segment according to FIG. 1 to FIG. 3, the roller segments 1 in a configuration according to the invention are characterized in that they comprise a multi-layer configuration with plastic material structures, visible in their transverse and longitudinal section (FIG. 4, FIG. 5). This structure defining a respective layer B and a layer C is embodied according to the invention as an immediate layer composite. In this context, the two-layer configuration, to be viewed from the inner through opening 10 in radial direction outwardly, is the preferred construction.

It has been found that an optimal embodiment of the roller segment 1 is already useable when it is comprised of only the two-layer structure with the layers B and C. The first layer B forms in this context the through opening 10 and this first layer B has correlated therewith the second layer C as the radial elastic jacket part.

For an efficient technically and economically improved realization of the two-layer roller segment 1 according to the invention, it is provided that it is comprised of different materials, i.e., two optimally combinable plastic materials. In this way, for the first time a construction of a roller segment 1 is realized that is free of support metals or similar additional support means within this layer composite. A surprisingly effective segment for different construction variants is provided on this basis. Based on the function-relevant properties of known elastic jacket parts 8 as layer C (FIG. 5), the inner plastic layer B can now be matched thereto such that the driving torque D still can be immediately taken up in the area of the through opening 10 (arrow D, FIG. 18).

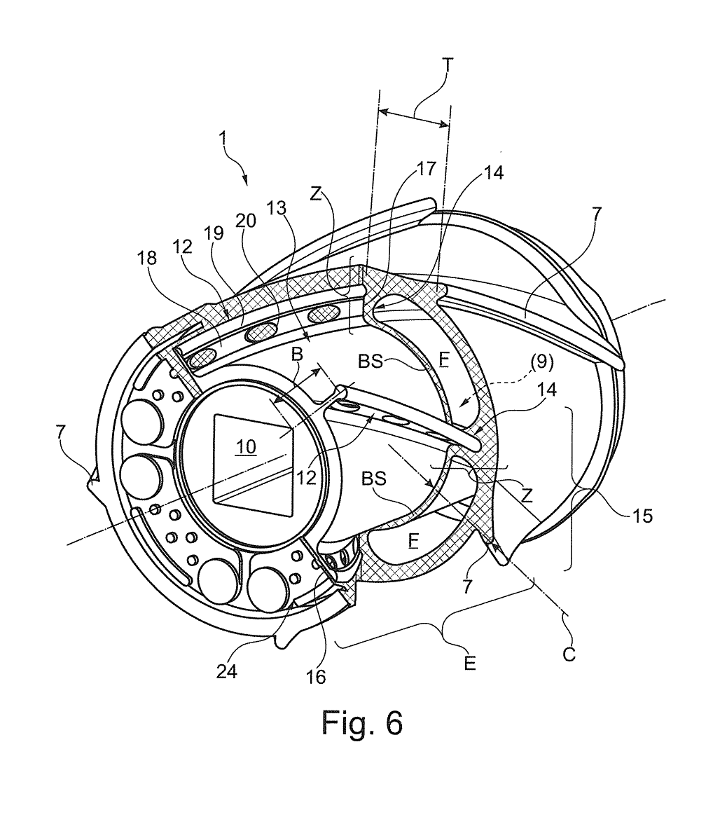

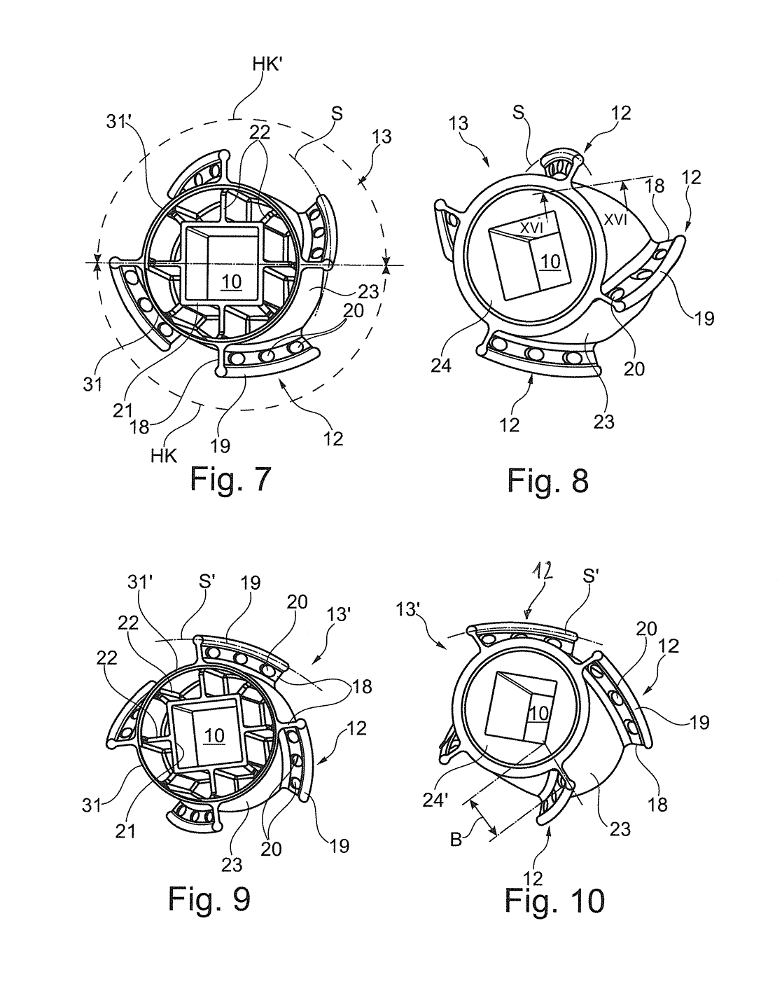

Based on the following overview illustrations of FIG. 6 to FIG. 16, it is apparent that the roller segment 1, as shown in the radial cross-section of FIG. 5, is provided with a formed core body 13 (FIG. 7) that comprises at least one circumferentially formed abutment profile 12. This formed core body 13 has correlated therewith at least one counter profile 14 on the jacket part 8 forming the formed jacket body 15. This structure B, C (FIG. 4, FIG. 5) that is thus comprised of two layers comprises in the area of the two engaging profiles 12 and 14 a fixed connection in such a way that the known functional properties of the separating stretch 4 (FIG. 17, FIG. 18) are ensured.

The constructive realization of the roller segment 1 provides that based on the inner formed core body 13, formed as a comparatively shape-stable substrate, the formed jacket body 15 forming a component unit therewith is to be dimensioned such that the formed jacket body 15, at least in radial direction, forms a functional area that is variable by manufacturing technology in its dimensions with a cross-sectional profiling that can be adjusted with regard to the conditions of use of the cleaning device 3. In this context, the formed jacket body 15 is at least in some areas formed of the generally known elastic material with which application-specific deformation areas and thus adjustments are possible in regard to the bulk material, fruits or similar transportation goods to be processed on the separating stretch 4.

The illustrations according to FIG. 7 to FIG. 10 disclose the optimal configuration of the formed core body 13, 13′ that can be provided as a semi-finished product. This semi-finished product forms with the formed jacket body 15, correlated at least in some areas therewith, the component unit E (FIG. 6) which is comprised of at least two different materials. In this context, it is apparent that the formed jacket body 15 is formed as a surrounding elastic envelope body which completely encloses the formed core body 13 in circumferential direction. In this context, it is provided that the formed core body 13 is completely enclosed (not illustrated in detail). Based on the respective hollow spaces and connecting zones, practically contact-free envelope areas between the bodies 13 and 15 can be provided also.

The envelope contour of the formed jacket body 15 which is marked in FIG. 6 by crosshatching illustrates that this envelope contour in an area 16 also can be embodied to extend to the end face of the roller segment 1, thus covering partially the end face of the inner formed core body 13.

Based on the preferred configuration of the component unit E with several of the abutment profiles 12 and counter profiles 14, a variable manufacture of the load-stable layer composite of the layers B and C is conceivable. In this context, different manufacturing technological variants are realizable wherein at least in some areas respective fused material, friction connected and/or form-fit connecting zones can be generated during the manufacture of the component unit E. This plurality of connections can also be expanded in that the formed core body 13 and/or the formed jacket body 15 are constructed and formed of several materials, in particular respective plastic material layers.

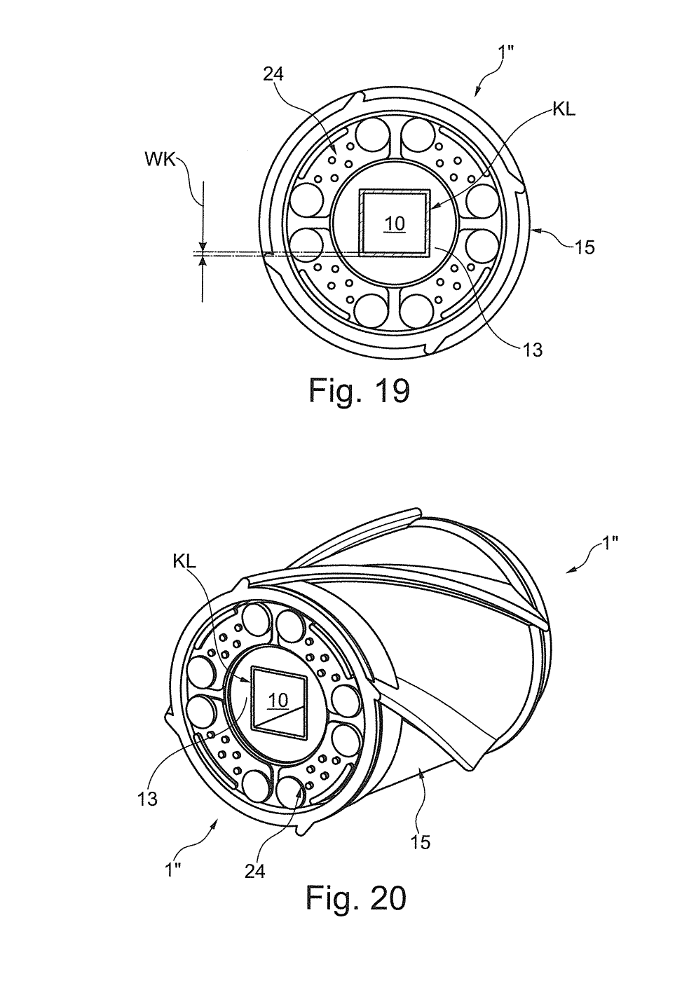

An important goal of the invention with regard to the use of the roller segment 1 (FIG. 19) is achieved in that the respective formed core body 13 is formed of a material that, in relation to the respective material characteristic values, at least has a greater stiffness than the formed jacket body 15. Preferably, the manufacturing costs are lowered in that the formed core body 13 is produced in particular of a material which is less expensive based on cost comparison.

This cost-optimized embodiment of the component unit E provides that the formed core body 13 comprised of thermoplastic material, thermosetting plastic material and/or glass fiber reinforced plastic material is combined with a formed jacket body 15 that is comprised at least in some areas of soft-elastic plastic material or rubber. The formed jacket body 15 forms in this context a layer B which is preferably made of polyurethane (PUR), thermoplastic polyurethane (TPU, TPE, TPO, TPV, TPC) or thermoplastic elastomer (TPS, TPA).

The perspective illustrations according to FIG. 7 to FIG. 10 illustrate the constructive configuration of the formed core body 13 whose abutment profile 12, that at least in some areas is interacting with the corresponding receiving structure of the counter profile 14 on the formed jacket body 15, is preferably formed like a thread profile with a pitch according to line S. This abutment profile 12 engages in connecting position a correspondingly extending receiving groove 17 as a counter profile 14 provided on the inner side of the formed jacket body 15 (FIG. 6).

From the section illustrations according to FIG. 4 to FIG. 6 the optimal configuration in the area of the outer layer C is apparent wherein this formed jacket body 15 forms here in longitudinal direction of the roller body 1 a deformation structure with intermediate webs Z and formed with generally known free spaces F (FIG. 5).The abutment profile 12 and the receiving groove 17 interact with each other in their area as an efficient shape-support connection. In this context, it is achieved that in circumferential direction of the roller segment 1 between the support connections, forming intermediate webs Z of a coiled extension, the respective free spaces F of the deformation structure are arranged. The deformation zone has correlated therewith externally, at an optimal spacing relative to the intermediate web Z, the respective entrainment profile 7 (arrow T, FIG. 6).

The constructive configuration in this area provides also that the free spaces F, extending in longitudinal direction of the formed jacket body 15 in a coil shape and comprising a bottom layer BS covering the formed core body 13, can define variable cross-sectional structures. In this context, it is provided that the free spaces F can form one or several partial areas which in cross-section comprise respective angular and/or round boundary contours. Also, it is conceivable that in the area F further partial webs are extending so that the free spaces F are divided (not illustrated in detail).

The formed core bodies 13 illustrated in FIG. 7 to FIG. 10 are formed each in the form of strip profiles 18 in the area of the abutment profiles 12 exhibiting a counterclockwise pitch S (FIG. 7) or a clockwise pitch S′ (FIG. 9). On these strip profiles 18 that follow the pitch S, S′, an expansion projection 19 can be provided which is oriented toward the counter profile 14 of the formed jacket body 15 (FIG. 6). In this way, the form-fit connection in radial or tangential tension/pressure direction is stabilized. In addition, the abutment profile 12 can be improved in its functional action in that respective transverse openings 20 are provided in the area of the strip profile 18.

Based on the formed core body illustrations shown in front view and rear view according to FIG. 7 and FIG. 8 or FIG. 9 and FIG. 10, it is also apparent that the formed core body 13, beginning at its central through opening 10, is provided preferably with a hollow profile support structure comprising a profile frame 21 surrounding it, instead of being provided with a “solid profile” (not illustrated). From this central profile frame 21, respective projecting webs 22 project radially away and they are connected with their other end to an envelope cylinder part 23. The strip profiles 18 extending in a coil shape are preferably monolithically formed on the outer circumference of the envelope cylinder part 23.

Based on the front views of FIG. 8 and FIG. 10, the partial closure of the inner support structure is apparent. The configuration of the “counterclockwise coiled” formed core body 13 (FIG. 7 and FIG. 8) is formed with a cover part 24. The embodiment according to FIG. 9 and FIG. 10 concerns the “clockwise coiled” formed core body 13 which has a cover part 24′ and provides only in the area of the pitch S “changed” abutment profiles 12. Advantageously, the respective formed core bodies 13 are monolithically formed wherein in principle also a multi-part configuration (not illustrated) is conceivable. With this web/hollow chamber construction of the formed core bodies 13 their material-saving configuration as a “lattice-type” or framework support body is apparent. In principle, it is however also provided that the formed core body 13, beginning at the longitudinally oriented through opening 10, is designed as a solid profile body in radial cross-section.

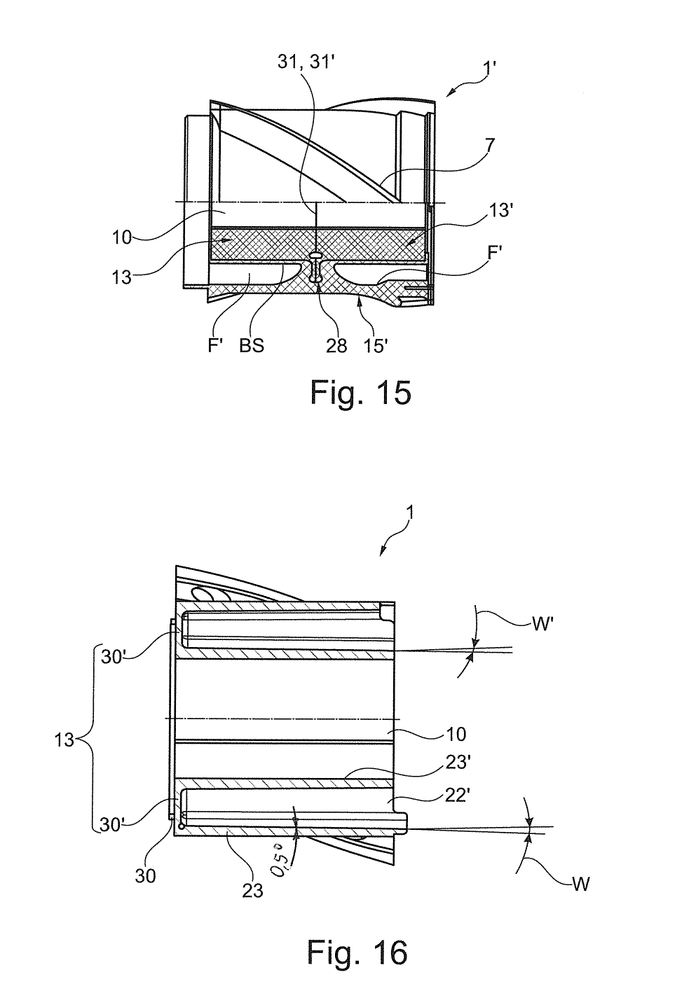

When looking at FIG. 7 to FIG. 10 and the section illustration according to FIG. 15, it is apparent that the complete roller segment 1′ can comprise also two formed core bodies 13, 13 or 13′, 13′ that are connectable in pairs. For this purpose, the formed core bodies 13, 13′ each are provided on a semicircle HK, HK′ with an end face profile area 31, 31′. In this way, the two parts 13, 13 or 13′, 13′ can be axially combined by means of a connection of the tongue and groove type (FIG. 15). It is understood that in this way the hollow spaces in the area of the inner support structure are adjoined and, on the other hand, with the two outer cover parts 24, 24′ a closed system is achieved.

In FIG. 19 and FIG. 20 a conceivable expansion of the roller segment 1″ of the two-layer structure B, C is illustrated. In this context, in the area of the through opening 10 a “third layer” is provided in the form of the inner structure KL arranged as an additional layer. This layer KL of comparatively minimal wall thickness WK can be comprised of variable materials. In this context, embodiments of metal or plastic material are conceivable. Preferably, also use of PU plastic material is provided in order to utilize the damping properties of elastic material characteristic values.

Based on the afore described roller segment 1, 1′, 1″ with the multi-layer structure B, C according to the invention illustrated in detail in FIG. 1 to FIG. 10 as well as FIG. 19 and FIG. 20, different process variants in the manufacture of the segments that are embodied at least as a two-layer unit result.

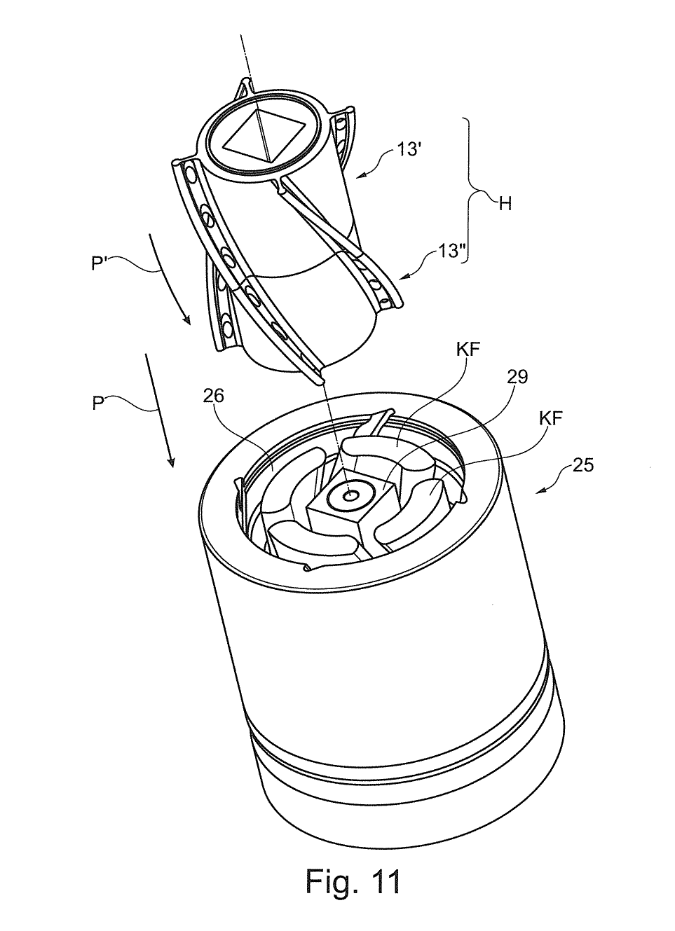

Based on a semi-finished product H (FIG. 11) manufactured as a formed core body 13 with abutment profile 12, a comparatively simple process control concerns connecting this semi-finished product with a formed jacket body 15, comprising at least in some areas the elastic jacket part 8 (FIG. 1), to a two-layer structure as a component unit E (FIG. 6). In principle, it is conceivable in this context that for constructing this two-layer component unit E, respective individual parts of at least two different plastic materials are used and the formed jacket body 15 is secured on the formed core body 13 by a connection technology (process not illustrated) that provides a friction connection and/or form fit connection. It is understood in this context that the formed core body 13 and the formed jacket body 15 are provided as respective semi-finished products comprising complementary connection profiles and then, by means of respective auxiliary tools (not illustrated), are connected to each other (similar: FIG. 11). In regard to “mechanical connection technology” it is conceivable that the connection of the two parts can be produced already between a single abutment profile 12 on the formed core body 13 and a single counter profile 14 on the formed jacket body 15 in such a way that the afore described torques D (FIG. 18) in mounted position (FIG. 17) can be transmitted. For these afore described process controls in regard to connecting for forming the two-layer unit, the combined manufacture by means of form fit and friction connection is provided.

A further variant of the manufacturing process for connecting the two layers B and C provides that at least in some areas between the formed jacket body 15 and formed core body 13 a fused material connection is produced. This fused material connection can in principle be embodied as an adhesive connection so that also a combination with the afore described friction connection and/or form fit connection variants is conceivable.

A preferred embodiment for producing the roller segment 1 according to the invention provides that a connecting technology on the basis of a casting process is utilized. In this context, the formed jacket body 15 can be generated by a casting or injection molding process that at least in some areas encloses the formed core body 13. In this case, simultaneous with the casting process also a fused material connection between the two layers B and C of the structure is produced (FIG. 11 to FIG. 14). In principle, it is also conceivable in this context to generate the two-layer structure B, C of the component unit E also by an injection molding process (not illustrated in detail), and a profile strand that is produced in this way is tailored to the corresponding segment length LS (FIG. 1).

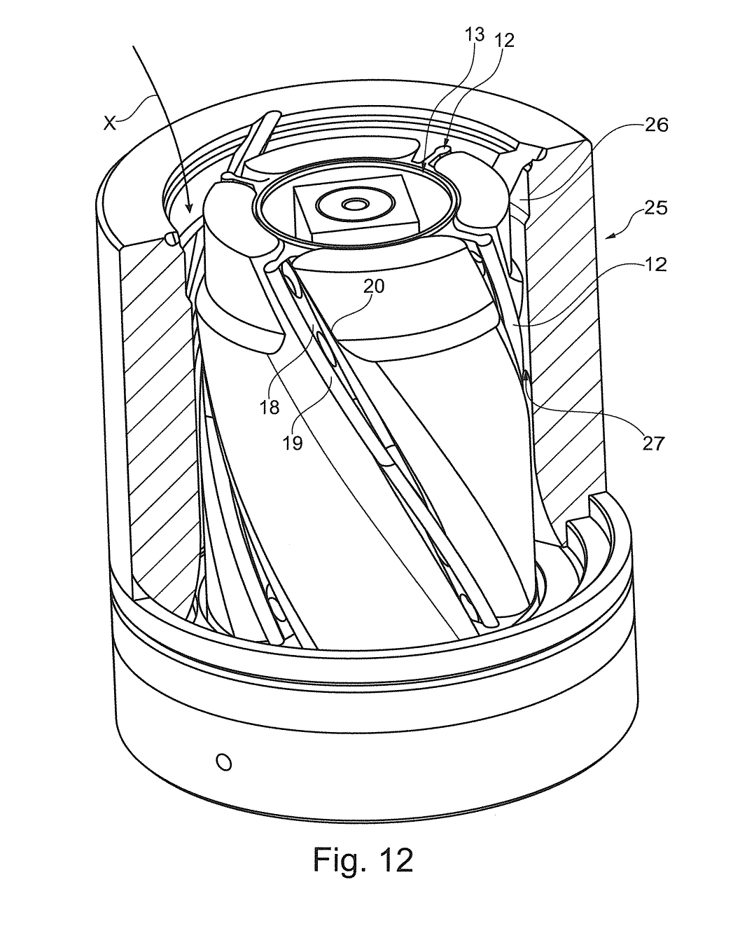

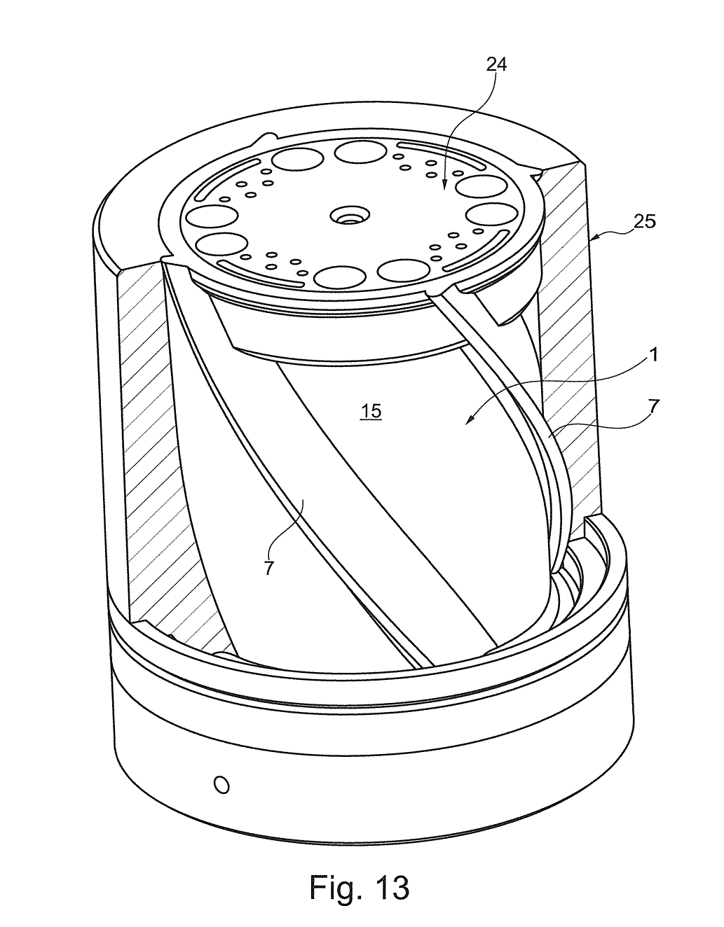

From the overview illustrations according to FIG. 11 to FIG. 14, the use of this casting process is apparent wherein here a casting mold 25 is used. The formed core body 13 which is provided as a semi-finished product H, here in a two-part embodiment with the formed core bodies 13 and 13′, is placed into the casting mold 25 (arrow P). Upon completion of this introduction phase (FIG. 12), the formed core body 13 is positioned such that a gap as a molding zone 27 remains between the inner wall 26 of the mold 25 and the outer circumference of the formed core body 13. In accordance with the thread-shaped or spiral-shaped pitch S, S′ of the abutment profiles 12 the insertion of the semi-finished product H is realized by means of a pivot/push movement P′-P (FIG. 11).

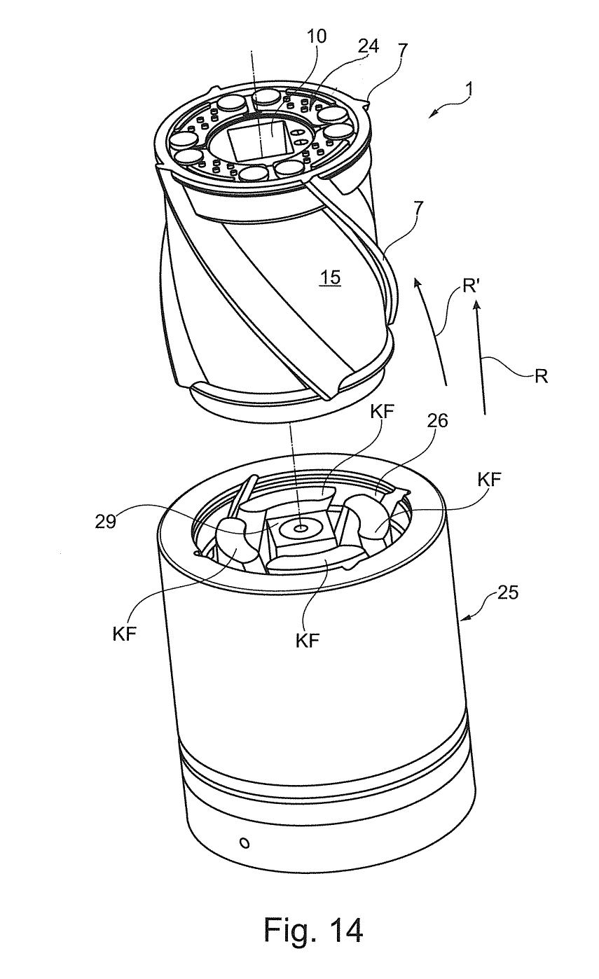

In direction of arrow X (FIG. 12), liquid plastic material is now filled into the molding zone 27 so that this contour that is substantially ring-shaped and that represents the profile contours of the jacket part C on the end product is completely filled. In this filling phase, the liquid plastic material also flows about the spirally extending abutment profiles 12 so that in their area the strip profile 18 and also the expansion projection 19 are engaged. At the same time, the transverse openings 20 are flowed through such that in these connecting zones a complete form fit is generated (FIG. 13). In this manufacture of the jacket layer C, the respective cores KF of the casting mold 25 are flowed about at the same time so that in this way the free spaces F (after removal, FIG. 14) are produced. In the area of the through opening 10, the shaped core body 13 is received on a complementary support pin 29 (FIG. 11). After hardening, the complete roller segment 1 is formed in the mold 25 that is shown in FIG. 13. The roller segment 1 can now be removed by means of a combined pivot/push movement R-R′ (FIG. 14) from the mold 25.

The afore described casting process P can be improved in regard to filling in the liquid plastic material in that an additional stabilizer (not illustrated) is introduced into the system. Also, it is conceivable that in place of the illustrated one-part mold 25 a multi-part, in particular divided, embodiment is used so that, if need be, the removal (arrow R′) is simplified because in this phase only the inner profilings in the area of the cores KF and the support pin 29 are effective.

A further variant of the process control for fusing the layers B and C provides that the component unit E of formed jacket body 15 and formed core body 13 can also be produced by a vulcanization process (not illustrated) realizing vulcanization at least in some areas.

In FIG. 15, a partially sectioned embodiment of a changed roller segment 1′ similar to FIG. 6 is illustrated wherein the roller segment 1′ is provided with a two-part configuration (similar to FIG. 11; semi-finished product H) in the area of formed core bodies 13, 13′. This two-part configuration in the inner structure of the roller segment 1′ is formed with a central connecting web 28 which is enclosed by the cast profiled jacket body 15.

The section illustration according to FIG. 16, according to section line XVI-XVI in FIG. 8, illustrates clearly the shape of the formed core body 13 in the area of the inner profile structure. This illustration shows in particular that in the area of a web 30 of the cover part the respective hollow spaces 22′ delimited by the walls 23, 23′ are closed by wall sections 30′. It is also apparent that the formed core body 13 that is also produced as a semi-finished product H by a casting process is formed according to FIG. 16 with slanted wall surfaces (angle W, W′) such that this component can be easily removed accordingly from the casting mold (not illustrated).

The specification incorporates by reference the entire disclosure of German priority document 10 2015 101 900.0 having a filing date of Feb. 10, 2015.

While specific embodiments of the invention have been shown and described in detail to illustrate the inventive principles, it will be understood that the invention may be embodied otherwise without departing from such principles.

What is claimed is:

1. A separating and cleaning device for an agricultural machine, the separating and cleaning device comprising:
at least one separating and cleaning stretch comprising at least one roller having a longitudinal roller axis and comprising one or more roller segments that, in a direction of the longitudinal roller axis are coaxially adjoining each other;
wherein the roller segments each comprise a jacket part, wherein the jacket part is comprised of an elastically yielding material and comprises outwardly projecting entrainment ribs;
wherein the roller segments each comprise a receiving area disposed radially inwardly of the jacket part and interacting with the jacket part;
wherein the receiving area comprises a through opening configured to receive a drive element for torque transmission;
wherein, beginning at the inner through opening, respectively, the roller segments are comprised of a multi-layer structure viewed in a radial outward direction.

2. The device according to claim 1, wherein the multi-layer structure comprises a metal-free two-layer structure comprising a first layer forming the through opening and a second layer that is radially correlated with the first layer and forms the jacket part.

3. The device according to claim 2, wherein the first and second layers are comprised of different materials and a driving torque of a drive element inserted into the through opening is immediately transmitted onto the material of the first layer without additional support means provided between the drive element and the material of the first layer.

4. The device according to claim 2, wherein the two-layer structure, viewed in a radial cross-section relative to the longitudinal roller axis, comprises a formed core body comprising at least one circumferentially formed abutment profile and further comprises a formed jacket body comprising at least one counter profile, wherein the formed core body and the formed jacket body are rotational fixed relative to each other by the at least one abutment profile and the at least one counter profile engaging each other.

5. The device according to claim 4, wherein the formed core body and the formed jacket body form together a component unit, wherein the formed core body is acting as a shape-stable structure in cross-section of the roller segment, and, beginning at the formed core body, the formed jacket body is dimensioned such that, at least in the radial outward direction, the formed jacket body defines an outer functional area of the roller segment, wherein the functional area is variable by manufacturing technology with regard to its dimensions and is comprised, at least in some areas, of elastic material.

6. The device according to claim 4, wherein the formed core body is a semi-finished product that forms together with the formed jacket body, correlated at least in some areas with the semi-finished product, a component unit, wherein the component unit is comprised of at least two different materials in such a way that the formed jacket body is formed as an elastic envelope body that completely surrounds in a circumferential direction the formed core body.

7. The device according to claim 4, wherein between the at least one abutment profile of the formed core body and the at least one counter profile of the formed jacket body at least in some areas a fused material connecting zone, a friction connection connecting zone, and/or a form-fit connecting zones is provided for producing a component unit of the formed core body and the formed jacket body.

8. The device according to claim 4, wherein the formed core body and/or the formed jacket body each are comprised of several materials.

9. The device according to claim 4, wherein the formed core body is made of a material that effects in relation to material characteristic values at least a greater stiffness compared to the formed jacket body and wherein the formed core body is manufactured of a less expensive material, based on cost comparison, than the jacket body.

10. The device according to claim 4, wherein a component unit is formed of the formed core body and of the formed jacket body, wherein the formed core body is comprised of thermoplastic material, thermosetting plastic material, and/or glass fiber reinforced plastic material, and wherein the formed jacket body is formed at least in some areas of soft-elastic plastic material or rubber selected from the group consisting of polyurethane, thermoplastic polyurethane, and thermoplastic copolymer.

11. The device according to claim 4, wherein the at least one abutment profile is radially outwardly projecting from the formed core body at least in some areas and is interacting with a corresponding receiving structure of the at least one counter profile of the formed jacket body provided at least in some areas, wherein the at least one abutment profile is shaped as a thread profile with a pitch and wherein the corresponding receiving structure of the at least one counter profile of the formed jacket body is a corresponding receiving groove on an inner side of the formed jacket body.

12. The device according to claim 11, wherein the formed jacket body comprises deformation structures comprising, in cross-section, free spaces that are delimited by intermediate webs, wherein the at least one abutment profile and the receiving groove are interacting as a support connection in the area of the deformation structures.

13. The device according to claim 12, wherein the free spaces extend in a longitudinal direction of the formed jacket body in a coil shape and comprise one or more channel structures with boundary contours that are angular and/or round in cross-section.

14. The device according to claim 4, wherein the at least one abutment profile is formed as a strip profile with a top-side expansion projection and the strip profile is provided with transverse openings.

15. The device according to claim 14, wherein the formed core body comprises a hollow profile support structure comprising a profile frame delimiting the through opening and further comprising projecting webs comprising first ends and second ends, wherein the first ends are connected to the profile frame and the projecting webs extend radially and outwardly away from the profile frame, wherein the hollow profile support structure further comprises an envelope cylinder part, wherein the second ends of the projecting webs are connected to the envelope cylinder part, wherein the envelope cylinder part comprises an outer circumference and the strip profile is arranged in a coil shape on the outer circumference.

16. The device according to claim 15, wherein two of the formed core bodies are provided and enclosed by the formed jacket body, wherein the formed core bodies comprise, at a first end, an end face contact contour with axial and radial complementary profile areas and further comprises, at a second end, a cover part covering the hollow profile support structure.

17. The device according to claim 4, wherein the formed core body comprises an additional layer provided in the through opening and lining the through opening at least in some areas.

18. A method for producing a roller segment according to claim 1, the method comprising:
producing a semi-finished product as a formed core body with at least one abutment profile;
connecting the semi-finished product with a formed jacket body, comprising at least in some areas an elastic jacket part, to form a component unit comprising a structure of at least two layers.

19. The method according to claim 18, further comprising selecting the formed core body and the formed jacket body to have at least two different material properties and securing the formed jacket body on the formed core body by a connecting technology effecting a friction connection, a form-fit connection and/or a fused material connection.

20. The method according to claim 18, further comprising:
providing the formed jacket body as a semi-finished product;
producing on the formed core body and on the formed jacket body complementary connection profiles in the form of the at least one abutment profile on the formed core body and in the form of at least one counter profile on the formed jacket body; and
producing a connection of the formed core body and of the formed jacket body between the at least one abutment profile and the at least one counter profile.

21. The method according to claim 18, further comprising:
producing the formed jacket body by a casting process and enclosing by the casting process the formed core body at least in some areas; and
producing at the same time a fused material connection between the formed core body and the formed jacket body.

22. The method according to claim 21, further comprising:
placing the formed core body into a casting mold so that a contoured molding zone remains for the formed jacket body;
filling into the contoured molding zone a liquid plastic material;
allowing the liquid plastic material to harden; and
removing the component unit from the casting mold, the component unit providing a two-part roller segment.

23. The method according to claim 22, further comprising introducing a stabilizer at least in the area of the formed core body and stiffening with the stabilizer in particular the through opening during the casting process.

24. The method according to claim 23, further comprising providing the casting mold as a multipart component group.

25. The method according to claim 18, further comprising producing by an injection molding process the structure of two layers of the component unit.
